(19) United States
(12) Patent Application Publication
(10) Pub. No.: US 2009/0287868 A1
(43) Pub. Date: Nov. 19, 2009

(54) MASTER DATA MANAGEMNT SYSTEM WITH IMPROVED DATA STRUCTURE AND STORAGE MEDIUM STORING THE MASTER DATA

(76) Inventor: Hwi-jung LEE, Seoul (KR)

Correspondence Address: Charles Y. Park, P.O. Box 34175, Washington DC, DC, 20043, US

(21) Appl. No.: 12/465,402

(22) Filed: May 13, 2009

(30) Foreign Application Priority Data
May 16, 2008 (KR) 10-2008-0045591

(51) Int. Cl. G06F 13/00

(52) U.S. Cl. 710/110

(57) ABSTRACT

Disclosed is a master data management (MDM) system having a unit master data storage and a unit master data update unit. The unit master data storage stores a plurality of pieces of unit master data having a data structure, in which master data is classified into the plurality of pieces of unit master data, a plurality of unique identifiers (IDs) are assigned respectively to the plurality of pieces of unit master data, and data items belonging to the master data each belongs to a corresponding one of the plurality of pieces of unit master data such that a data item belonging to a piece of unit master data does not belong to another piece of unit master data. The unit master data update unit may provide a user interface allowing one of creation, deletion, and correction of a record composed of data item fields belonging to each unit master data, and reflect the result of the creation, deletion, or correction performed through the user interface in the unit master data storage.

### CROSS-REFERENCE TO RELATED APPLICATION(S)

This application claims the benefit under 35 U.S.C. §119(a) of a Korean Patent Application No. 10-2008-0045591, filed on May 16, 2008, the disclosure of which is incorporated herein in its entirety by reference for all purposes.

### TECHNICAL FIELD

The following description relates to data management, and more particularly, to management of data, for example, master data, by a plurality of data systems, for example, systems such as an Enterprise Resource Planning (ERP) system, Supply Chain Management (SCM) system, maintenance management system, and the like, which are legacy systems for business activities.

### BACKGROUND

Business activities include utilization of various IT systems and data processing by IT systems. Management of fundamental data, which may be referred to as “master data”, among data that can be processed by IT systems, is becoming important. Master data is typically fundamental data for processing various kinds of information through data systems, and is referred to by other data and not modified. In managing master data, it is important to consider both maintenance of the master data and application of support solutions and business processes for stable connection between systems.

In business IT environments in which many data processing systems operate together, most of the data processing systems have their own independent database systems. Accordingly, introduction of data processing systems generally leads to a business community possessing many database systems. Also, when new data processing systems are installed, a method of extracting related information from databases of existing data processing systems and loading and operating the extracted information in the new systems independently, or a method of operating the new systems in association with some databases of existing systems, has been generally used.

FIG. 1 is an example for explaining how various systems manage master data.

A data processing system obtains desired information from its own database or through direct data exchange with another data processing system. However, in this method, since maser data is scattered throughout individual databases of data processing systems, overlapping management of master data is inevitable. For example, vendor names may be the same as supplier names and product names may be the same as material names. In this case, estimation of master data to analyze records and statistics is difficult. Also, central control of master data may become difficult since the master data is continuously modified while the system operates.

In order to overcome the above, quality maintenance of master data and applications according to business processes may be supported by establishing a Master Data Management (MDM) solution through integration of master data of data systems. However, a conventional MDM system has been established as a central storage which is not a structured system for combining master data but a general information integrated structure, and provided in the form of a model which can be associated with other systems.

FIG. 2 is an example for explaining how a general MDM system configures and manages master data.

As shown in FIG. 2, the MDM system configures master data as a single structure in a separate database and associates the master data with a data system requiring it. However, in this method, the same attributes of the same master data may be managed in overlapping fashion in individual MDM databases. For example, information about vendor names, suppliers, designated vendors, and worksites may be managed in overlapping fashion. Also, organically combining master data suitably for business processes required by each department of a company is not easy. Also, a data structure of master data has to be flexible in order to associate it with various other data systems, but 1-dimensional data structures may not ensure such flexibility in configuration.

FIG. 3 shows an example of a conventional configuration of material master data.

The material master data includes a record starting with a material field followed by a product field, a vendor field and a worksite field. A unique identifier (ID) is given to the record. That is, in the conventional example, a variety of business-associated information, such as products, vendors, worksites, and the like, as well as materials, is contained in the material master data and managed together by a single system. However, in this case, when any one of product information, vendor information and worksite information is changed without any change of material information, a new record should be created. As a result, overlapping material information is created. The conventional MDM system is a model of physically integrating scattered master data while maintaining the existing data structure shown in FIG. 3 without reconfiguration. However, the conventional MDM system may have the following problems managing master data.

First, since users trying to register or use master data use systems that depend on a data structure that does not take into account their business needs, business efficiency may suffer or the users may experience difficulties in obtaining desired information.

Second, since master data is typically configured by combining items (columns or attributes) containing information, various data items (attributes) differing in kind, creation object and management object are managed with a single ID, and data item (attribute) groups and items (attributes) overlap with other master data so that data consistency cannot be ensured and data quality deteriorates. Data management departments have experienced difficulties in quality management since having to manage data that neither belongs to nor was created by the department itself. Furthermore, quality deterioration in any part of data is a burden to users in charge of data management.

Third, a plurality of pieces of data may be created for the same physical entity, which leads to confusion in management and analysis. For example, if a product has a different price depending on a vendor, different material data has to be created for each vendor, which makes it difficult to know the total stock of the product or calculate the total retail value of products in stock.

### SUMMARY

Accordingly, in one general aspect, there is provided a method of data management in which a data structure of master data is reconfigured by separating physical units of data from conceptual units of data using the physical units of data, and systemizing the resultant data.

According to another aspect, there is provided a master data management (MDM) system including: a unit master data storage configured to store a plurality of pieces of unit master data having a data structure, in which master data is classified into the plurality of pieces of unit master data, a plurality of unique identifiers (IDs) are assigned respectively to the plurality of pieces of unit master data, and data items belonging to the master data each belongs to a corresponding one of the plurality of pieces of unit master data such that a data item belonging to a piece of unit master data does not belong to another piece of unit master data; and a unit master data update unit configured to provide a user interface allowing one of creation, deletion, and correction of a record composed of data item fields belonging to each unit master data, and reflect the result of the creation, deletion, or correction performed through the user interface in the unit master data storage.

The MDM system may further include: a combined master data storage configured to store a plurality of combined master data records that are ID combinations of predetermined pieces of the unit master data; and a combined master data inquiry unit configured to provide, on a display, data items of unit master data configuring combined master data records designated as records for inquiry among the plurality of combined master data records, using IDs of the unit master data configuring the combined master data records.

The combined master data may be at least one combination of record IDs belonging to unique IDs of the unit master data.

The combined master data may be classified and stored according to business needs.

The MDM system may further include a combined master data update unit configured to provide a user interface allowing one of creation, deletion, and correction of the combined master data, and reflect the result of the creation, deletion, or correction performed through the user interface in the combined master data storage.

According to still another aspect, there is provided a computer-readable storage medium storing master data, the master data managed by a master data management (MDM) system and having a data structure in which the master data is classified into a plurality of pieces of unit master data, a plurality of unique identifiers (IDs) are assigned respectively to the plurality of pieces of unit master data, and data items belonging to the master data each belongs to a corresponding one of the plurality of pieces of unit master data such that a data item belonging to a piece of unit master data does not belong to another piece of unit master data.

Each unit master data may correspond to a physical entity.

In the data structure, a plurality of pieces of combined master data, which are ID combinations of predetermined pieces of the unit master data, may be configured.

Each combined master data may be a combination of record IDs belonging to unique IDs of the unit master data.

By dividing existing master data in which various kinds of data are mixed and managed with a single ID into “unit master data” which represents physical entities, and reconfiguring the unit master data according to business needs to create “combined master data”, physical overlapping of master data may be prevented. For example, if products with the same specification are sold by two vendors at different prices, existing master data has an ID structure composed of items such as material, vendor, price, etc., and the products with the same specification are created as two pieces of data. However, if master data is classified into unit master data and combined master data and stored, overlapping of material data may be avoided since physical materials have a single material ID and combined master data is configured when the material data needs to be associated with vendors and price information.

Since defining unit master data in this way can clarify an object of master data management, successive quality management of data may be possible and causes of quality deterioration may become more clear, which may innovatively contribute to quality enhancement and efficient maintenance of business data.

Also, if any content of unit master data changes when there are a plurality of pieces of combined master data using the unit master data, the change may be reflected in real time in all of the combined master data, and accordingly, data inconsistency may be prevented.

Other features and aspects will be apparent from the following detailed description, the drawings, and the claims.

### BRIEF DESCRIPTION OF THE DRAWINGS

FIG. 1 is a diagram illustrating an example for explaining how various systems manage master data.

FIG. 2 is a diagram illustrating an example for explaining how a general Master Data Management (MDM) system configures and manages master data.

FIG. 3 is a diagram illustrating an example of a configuration of material master data.

FIG. 4 is a diagram illustrating a MDM system according to an exemplary embodiment.

FIG. 5 is a diagram illustrating an example of a configuration of unit master data according to an exemplary embodiment.

FIG. 6 is a diagram illustrating an example of a configuration of records of material master data according to an exemplary embodiment.

FIG. 7 is a diagram illustrating an example of a configuration of combined master data according to an exemplary embodiment.

FIG. 8 is a diagram illustrating an example in which master data is combined according to an exemplary embodiment.

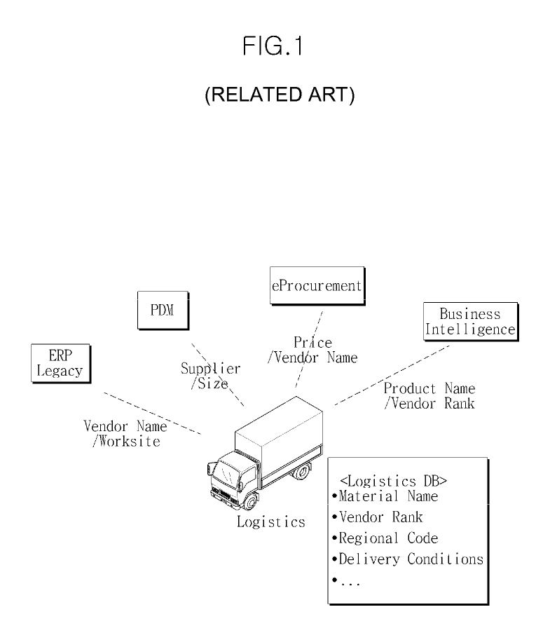

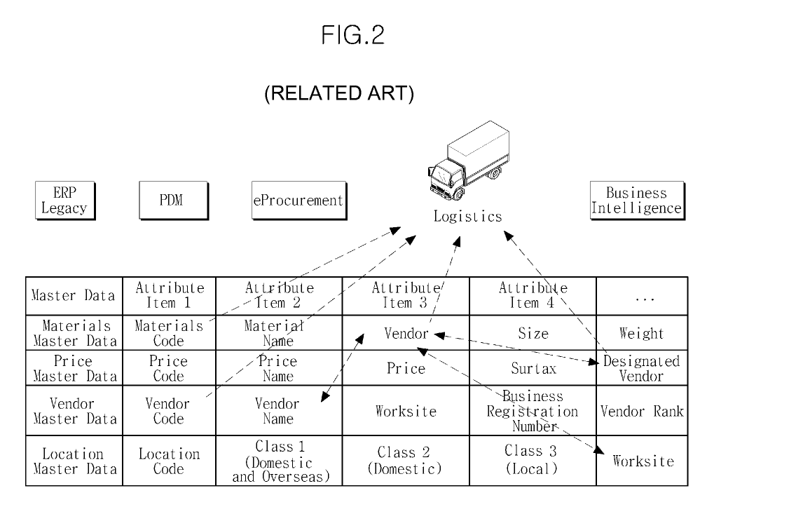

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

According to one aspect, a data structure is established to divide and combine configuration data by subdividing a lower structure of the configuration data, in order to more efficiently configure a master data management (MDM) structure and a dispersed master data structure of an existing data management system.

Through more efficient configuration of a master data structure, reproduction, data linking and management of additional data using the master data may be optimized.

For example, important data used in a materials data management system may be classified into materials master data and vendor master data. The materials master data may include combinations of essential configuration data, such as material names, material codes, material specifications, and the vender master data may include additional data such as information about companies selling manufacturing materials. Also, by combining the master data, combinations of various pieces of data for business activities may be easily configured.

FIG. 4 illustrates a master data management (MDM) system according to an exemplary embodiment. As shown in FIG. 4, the MDM system may include a unit master data storage 100, a combined master data storage, and a data management unit 200. The data management unit 200 may include a unit master data update unit 210, a combined master data inquiry 220, and a combined master data update unit 230.

The unit master data storage 100 stores a plurality of pieces of unit master data. The unit master data may mean master data having physical entities. For example, a material, a product, a vendor, and a worksite may be a piece of unit master data since they each corresponds to a physical entity. A unique identifier (ID) is assigned to each piece of unit master data, and each data item (for example, a material name, a product name, a vendor address, a vendor telephone number, etc.) belonging to master data belonging to a piece of the unit master data does not belong to another piece of the unit master data. The unit master data according to an exemplary embodiment having the data structure described above will be further described below.

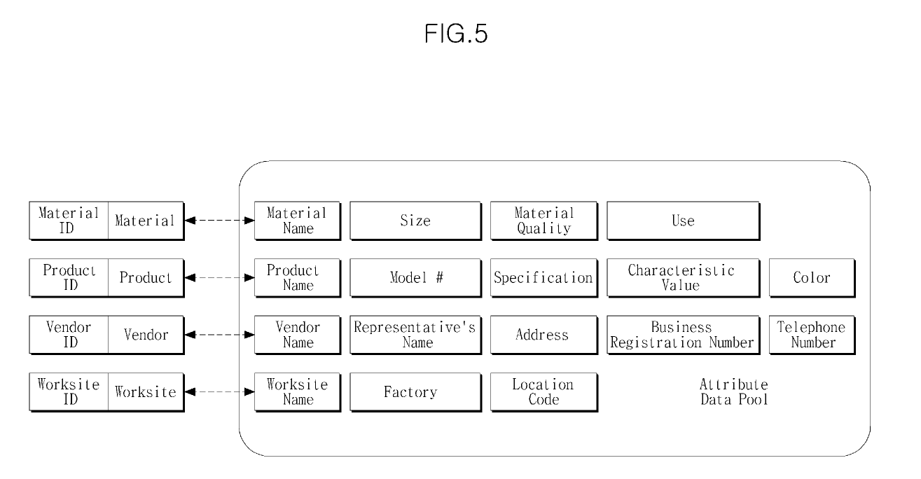

FIG. 5 illustrates an example of unit master data according to an exemplary embodiment.

Referring to FIG. 5, information about materials, information about products, information about vendors and information about worksites are classified into unit master data, and each unit master data is assigned a unique ID. Also, entire data items (an attribute data POOL) are classified according to the unit master data such that each data item belongs to a corresponding one of the unit master data according to its kind.

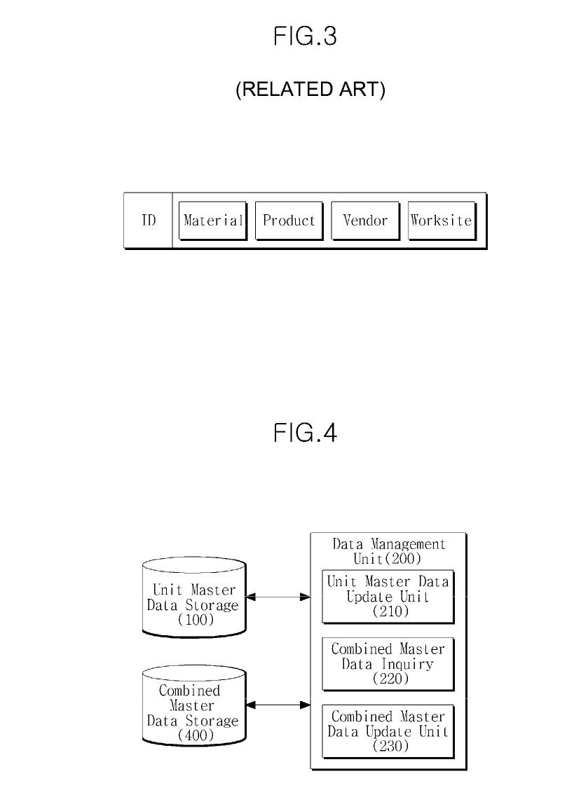

This configuration of unit master data may be made by the following process. First, different kinds of data mixed in existing master data are classified according to a type of data items. For example, materials master data is classified into a material item, a product item, a vendor item, and a worksite item, as illustrated in FIG. 3.

Then, the classified data items are reconfigured into unit master data corresponding to a physical entity. At this time, the data items are reconfigured in such a manner that a data item belonging to a piece of unit master data does not belong to another piece of unit master data. As illustrated in FIG. 5, items regarding material name, size, material quality, and use are classified as materials master data, and items regarding material name, model number, specifications, characteristic values, and color are classified as product master data. Also, items regarding vendor name, representative name, address, business registration number and telephone number are classified as vendor master data, and items regarding worksite name, factory, and location code are classified as worksite master data. These classifications are based on, for example, logical relationships between unit master data for physical entities. Finally, a classification structure and attribute structure are configured for the configured unit master data.

A data structure of unit master data according to an exemplary embodiment may have the following features. First, each unit master data is distinctly defined as corresponding to a physical entity excluding a view of business. Second, each unit master data is configured as a combination of corresponding data items, data items belonging to a piece of unit master data cannot belong to any other unit master data. Third, each unit master data has a unique ID. Fourth, each unit master data has an independent classification structure and a corresponding attribute structure.

The classification structure and attribute structure will now be further described. Master data may be identified using the classification structure due to its complexity, and has different attributes according to their classifications. For example, materials master data “motor” has attributes, such as “voltage”, “number of poles”, “r.p.m.”, and the like, whereas materials master data “pump” has attributes, such as “lift”, “capacity”, “material quality” and the like. As such, each unit master data has an independent classification structure and its own distinct attributes.

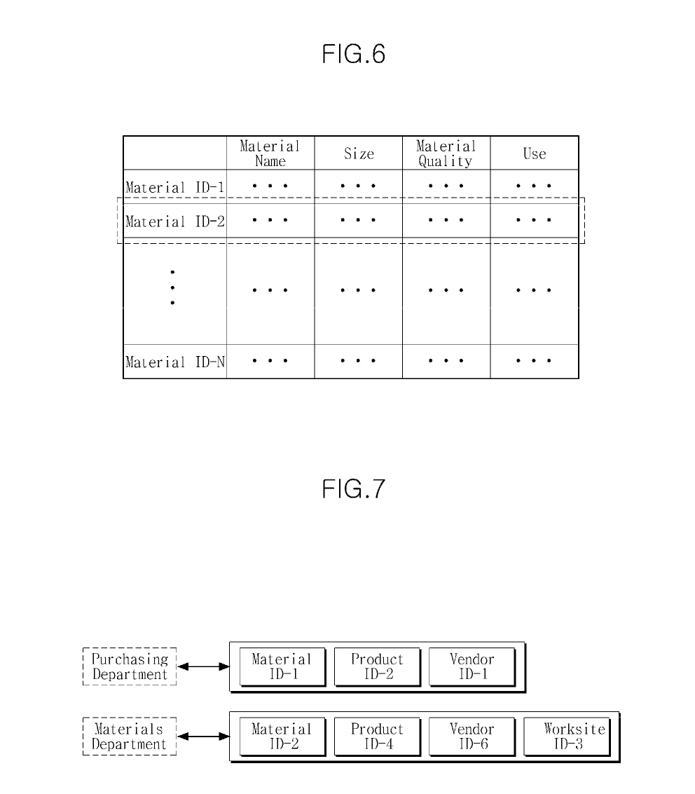

FIG. 6 illustrates an example of records of materials master data according to an exemplary embodiment.

As illustrated in FIG. 6, materials master data includes items of “material name”, “size”, “material quality”, and “use”, and the more items, the more records. Each record has unique identification information associated with a material ID for distinguishing it from other records. For example, unique identification information “material ID-2” of a record is shown in a dotted box.

Referring back to FIG. 4, the data management unit 200 may manage master data and includes the unit master data update unit 210. The unit master data update unit 210 may provide a user interface screen allowing editing (creation, deletion, correction, etc.) of the unit master data records shown in FIG. 6.

Also, the unit master data update unit 210 may update data stored in the unit master data storage 100 by creating, deleting, or correcting records according to a record creation command, a record deletion command, or a record correction command input through the user interface screen.

As such, existing master data in which various kinds of data have been mixed and managed with a single ID is classified into “unit master data”, which are units of data corresponding to a physical entity, and independent management is performed for each piece of unit master data.

According to another aspect, the MDM system may include the combined master data storage 400 and the combined master data inquiry unit 220. Also, the MDM system may further includes the combined master data update unit 230. The combined master data storage 400 may store a plurality of combined master data records which are ID combinations of predetermined pieces of the unit master data described above. In other words, combined master data newly defined according to an exemplary embodiment is not composed of actual data but of records which are ID combinations of unit master data. The combined master data may be composed of various combinations of unique IDs of unit master data.

FIG. 7 illustrates an example of combined master data according to an exemplary embodiment.

A first record is composed of three fields on which “material ID-1”, “Product ID-4” and “Vendor ID-1” corresponding to record IDs of unit master data are written respectively. A second record is composed of four fields on which “material ID-2”, “Product ID-4”, “Vendor ID-6”, and “Worksite ID-3” corresponding to record IDs of unit master data are written respectively. According to an aspect, the combined master data is classified and stored for each creation object which creates the combined master data. A creation object may be a department of a company. FIG. 7 shows an example where a creation object of the first record is a purchasing department, and a creation object of the second record is a materials department. The reason for classifying combined master data for respective departments may be to achieve flexible data management according to various business needs.

Then, a process of configuring the combined master data may be performed as follows. First, the combined master data is configured using unit master data as parameters according to business needs. After the combined master data is configured, IDs existing in the unit master data are combined to create records of the combined master data.

Referring back to FIG. 4, the combined master data inquiry unit 220 may be configured to inquire about the combined mater data. For example, a member of a purchasing department may access the master data management system, check a list of combined master data mapped to the purchasing department, and select an item on the list to inquire about a desired piece of the combined master data. Then, the combined master data inquiry unit 220 provides, on a screen, data items of unit master data stored in the unit master data storage 100 using IDs of the corresponding unit master data recorded in fields configuring combined master data records designated as records for inquiry. Accordingly, members of respective departments may inquire about master data in an optimal format according to their business needs.

The combined master data update unit 230 may provide a user interface allowing editing (creation, deletion, correction, etc.) of the combined master data records shown in FIG. 7. Also, the combined master data update unit 230 may update data stored in the combined master data storage 400 by creating, deleting, or correcting records according to a record creation command, a record deletion command, or a record correction command which is input through the user interface. Accordingly, each department may create various combined master data according to its needs.

The features of the exemplary combined master data described above may be summarized below. The combined master data is defined as a relationship between unit master data. The combined master data has only ID information of unit master data, not physical data items. The combined master data has independent IDs which are distinguished from IDs of unit master data. Physical master data values of the combined master data cannot be changed, and changing values is possible only in unit master data. Changeable data in the combined master data is only IDs of unit master data, and changing IDs does not change values, only the relationship between data. The features are provided only as illustration and other implementations may have a different set of features.

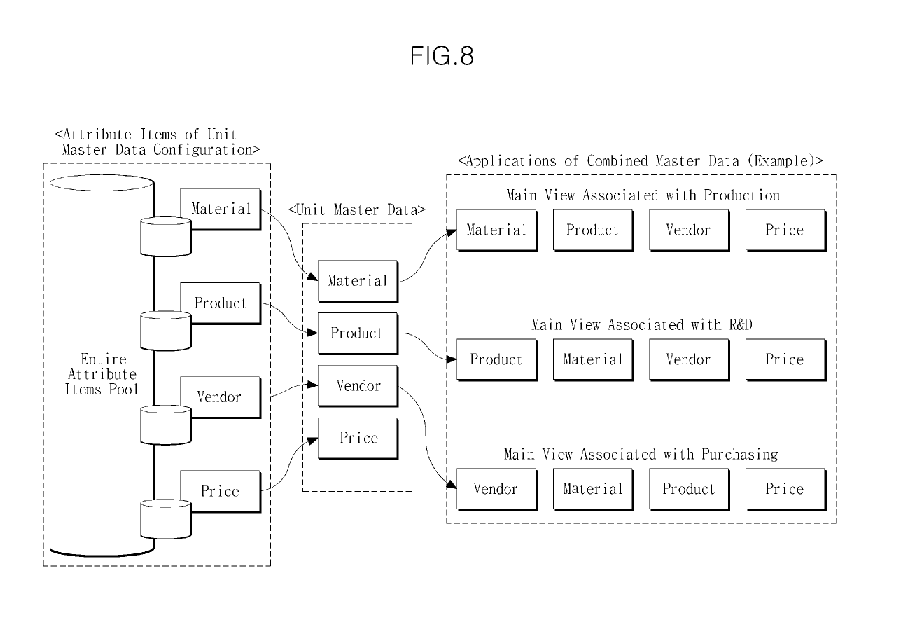

FIG. 8 illustrates an example in which unit master data is combined with combined master data according to an exemplary embodiment.

In the example shown in FIG. 8, combined master data obtained by combining ID of unit master data is applied to production, R&D and purchasing fields. In addition, in the example of FIG. 8, “price”, not corresponding to a physical entity, is used as unit master data, to illustrate a different case and basically, unit master data is composed of data having definite physical entities. FIG. 8 relates to a case where there is data not corresponding to a physical entity but having to be classified into unit master data for business.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A master data management (MDM) system comprising:
a unit master data storage configured to store a plurality of pieces of unit master data having a data structure, in which master data is classified into the plurality of pieces of unit master data, a plurality of unique identifiers (IDs) are assigned respectively to the plurality of pieces of unit master data, and data items belonging to the master data each belongs to a corresponding one of the plurality of pieces of unit master data such that a data item belonging to a piece of unit master data does not belong to another piece of unit master data; and
a unit master data update unit configured to provide a user interface allowing one of creation, deletion, and correction of a record composed of data item fields belonging to each unit master data, and reflect the result of the creation, deletion, or correction performed through the user interface in the unit master data storage.

2. The MDM system of claim 1, further comprising:
a combined master data storage configured to store a plurality of combined master data records that are ID combinations of predetermined pieces of the unit master data; and
a combined master data inquiry unit configured to provide, on a display, data items of unit master data configuring combined master data records designated as records for inquiry among the plurality of combined master data records, using IDs of the unit master data configuring the combined master data records.

3. The MDM system of claim 2, wherein the combined master data is at least one combination of record IDs belonging to unique IDs of the unit master data.

4. The MDM system of claim 2, wherein the combined master data is classified and stored according to business needs.

5. The MDM system of claim 2, further comprising a combined master data update unit configured to provide a user interface allowing one of creation, deletion, and correction of the combined master data, and reflect the result of the creation, deletion, or correction performed through the user interface in the combined master data storage.

6. A computer-readable storage medium storing master data, the master data managed by a master data management (MDM) system and having a data structure in which:
the master data is classified into a plurality of pieces of unit master data;
a plurality of unique identifiers (IDs) are assigned respectively to the plurality of pieces of unit master data; and
data items belonging to the master data each belongs to a corresponding one of the plurality of pieces of unit master data such that a data item belonging to a piece of unit master data does not belong to another piece of unit master data.

7. The computer-readable storage medium of claim 6, wherein each unit master data corresponds to a physical entity.

8. The computer-readable storage medium of claim 6, wherein in the data structure, a plurality of pieces of combined master data, which are ID combinations of predetermined pieces of the unit master data, are configured.

9. The computer-readable storage medium of claim 8, wherein each combined master data is a combination of record IDs belonging to unique IDs of the unit master data.
